(19) United States
(12) Patent Application Publication
(10) Pub. No.: US 2025/0056338 A1
(43) Pub. Date: Feb. 13, 2025

(54) MANAGING MASTER CELL GROUP CONFIGURATIONS

(71) Applicant: Nokia Technologies Oy, Espoo (FI)

(72) Inventors: Nihar Ranjan JENA, Bangalore (IN); Umur KARABULUT, Munich (DE); Srinivasan SELVAGANAPATHY, Bangalore (IN); Ahmad AWADA, Munich (DE)

(21) Appl. No.: 18/798,825

(22) Filed: Aug. 9, 2024

(30) Foreign Application Priority Data
Aug. 11, 2023 (IN) 202311054126

(51) Int. Cl. H04W 36/00

(52) U.S. Cl. CPC H04W 36/0069; H04W 36/0061

(57) ABSTRACT

Examples of the disclosure relate to managing Master Cell Group (MCG) configurations during PSCell (Primary Secondary Cell) changes. In examples of the disclosure a User Equipment comprises means for receiving, from a master node, preparation configurations for at least a first candidate target PSCell and a second candidate target PSCell, wherein same MCG configuration is shared among at least the first candidate target PSCell and the second candidate target PSCell. The User Equipment also comprises means for performing a PSCell change from a source PSCell to the first candidate target PSCell and retaining the preparation configurations after the PSCell change. The PSCell change is performed without a PCell change.

### TECHNOLOGICAL FIELD

Examples of the disclosure relate to managing Master Cell Group (MCG) configurations. Some relate to optimized selective activation and to managing Master Cell Group (MCG) configurations during PSCell (Primary Secondary Cell) changes.

### BACKGROUND

In New Radio-Dual Connectivity (NR-DC) a User Equipment (UE) is connected to a Master Node (MN) and a Secondary node (SN) simultaneously. Both the MN and the SN can be associated with multiple cells or carriers. The multiple cells or carriers can be referred to as a Master Cell Group (MCG) and a Secondary Cell Group (SCG). The respective groups have one primary cell that carries the Physical Uplink Control Channel (PUCCH) and may have one or more secondary cells. The primary cell of the MCG is the PCell and the primary cell of the secondary cell is the PSCell. The respective cell groups can be changed during handover procedures.

### BRIEF SUMMARY

According to various, but not necessarily all, examples of the disclosure, there is provided a User Equipment comprising means for: receiving, from a master node, preparation configurations for at least a first candidate target PSCell (primary secondary cell) and a second candidate target PSCell, wherein same MCG (Master Cell Group) configuration is shared among at least the first candidate target PSCell and the second candidate target PSCell; performing a PSCell change from a source PSCell to the first candidate target PSCell; and retaining the preparation configurations after the PSCell change, wherein the PSCell change is performed without a PCell change.

The preparation configuration for each candidate target PSCell may comprise a full SCG (secondary cell group) configuration of the corresponding candidate target PSCell.

The preparation configurations may be associated with a reference SCG (secondary cell group) configuration and the preparation configurations comprise a delta SCG configuration for each candidate target PSCell, wherein respective delta SCG configurations indicate differences between the reference SCG Configuration and an SCG configuration of a corresponding candidate target PSCell.

The preparation configurations may be associated with a full MCG configuration that is shared among at least the first candidate target PSCell and the second candidate target PSCell.

The preparation configurations may comprise, for respective candidate target PSCell, a full MCG configuration, wherein the full MCG configuration is the same for at least the first candidate target PSCell and the second candidate target PSCell.

The preparation configurations may be associated with a reference MCG configuration and the preparation configurations comprise a delta MCG configuration for respective candidate target PSCells, wherein respective delta MCG configurations indicate differences between the reference MCG configuration and an MCG configuration of a corresponding candidate target PSCell, and wherein the MCG configuration shared among the at least the first candidate target PSCell and the second candidate target PSCell is the reference MCG configuration.

The reference MCG configuration may comprise the MCG configuration applicable to the source PSCell.

The means of the User Equipment may also be configured for receiving an indication that the same MCG configuration is shared among at least the first candidate target PSCell and the second candidate target PSCell.

The indication may be received in a Radio Resource Control message.

The indication may comprise a delta MCG configuration that indicates no change between the MCG configuration for the first candidate target PSCell and the MCG configuration for the second candidate target PSCell.

The preparation configurations may be CPC (Conditional PSCell Change) configurations.

The MCG configuration may be used to maintain a link to the master node.

The MCG Configurations and the SCG Configurations may comprise at least one of:
Radio Link Control parameters;
Medium Access Control parameters;
Packet Data Convergence Protocol parameters.

The means of the User Equipment may be for: performing a further PSCell change from the first candidate target PSCell to the second candidate target PSCell; and accessing the retained preparation configurations to enable the same MCG configuration to be used for the first candidate target PSCell and the second candidate target PSCell.

According to various, but not necessarily all, examples of the disclosure, there is provided a method comprising: receiving, from a master node, preparation configurations for at least a first candidate target PSCell (primary secondary cell) and a second candidate target PSCell, wherein same MCG (Master Cell Group) configuration is shared among at least the first candidate target PSCell and the second candidate target PSCell; performing a PSCell change from a source PSCell to the first candidate target PSCell; and retaining the preparation configurations after the PSCell change, wherein the PSCell change is performed without a PCell change.

According to various, but not necessarily all, examples of the disclosure, there is provided a computer program, comprising program instructions, which when executed by a User Equipment, causes the User Equipment at least to perform: receiving, from a master node, preparation configurations for at least a first candidate target PSCell (primary secondary cell) and a second candidate target PSCell, wherein same MCG (Master Cell Group) configuration is shared among at least the first candidate target PSCell and the second candidate target PSCell; performing a PSCell change from a source PSCell to the first candidate target PSCell; and retaining the preparation configurations after the PSCell change, wherein the PSCell change is performed without a PCell change.

According to various, but not necessarily all, examples of the disclosure, there is provided a Master Node comprising means for: requesting configuration information from at least a first candidate target secondary node associated with a first candidate target PSCell and at least a second candidate target secondary node associated with a second candidate target PSCell; receiving the requested configuration information; and transmitting, to a User Equipment, preparation configurations for at least the first candidate target PSCell (primary secondary cell) and the second candidate target PSCell, wherein same MCG (Master Cell Group) configuration is shared among at least the first candidate target PSCell and the second candidate target PSCell.

According to various, but not necessarily all, examples of the disclosure, there is provided a method comprising: requesting configuration information from at least a first candidate target secondary node associated with a first candidate target PSCell and at least a second candidate target secondary node associated with a second candidate target PSCell; receiving the requested configuration information; and transmitting, to a User Equipment, preparation configurations for at least the first candidate target PSCell (primary secondary cell) and the second candidate target PSCell, wherein same MCG (Master Cell Group) configuration is shared among at least the first candidate target PSCell and the second candidate target PSCell.

According to various, but not necessarily all, examples of the disclosure, there is provided a computer program, comprising program instructions, which when executed by a Master Node, causes the Master Node at least to perform: requesting configuration information from at least a first candidate target secondary node associated with a first candidate target PSCell and at least a second candidate target secondary node associated with a second candidate target PSCell; receiving the requested configuration information; and transmitting, to a User Equipment, preparation configurations for at least the first candidate target PSCell (primary secondary cell) and the second candidate target PSCell, wherein same MCG (Master Cell Group) configuration is shared among at least the first candidate target PSCell and the second candidate target PSCell.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

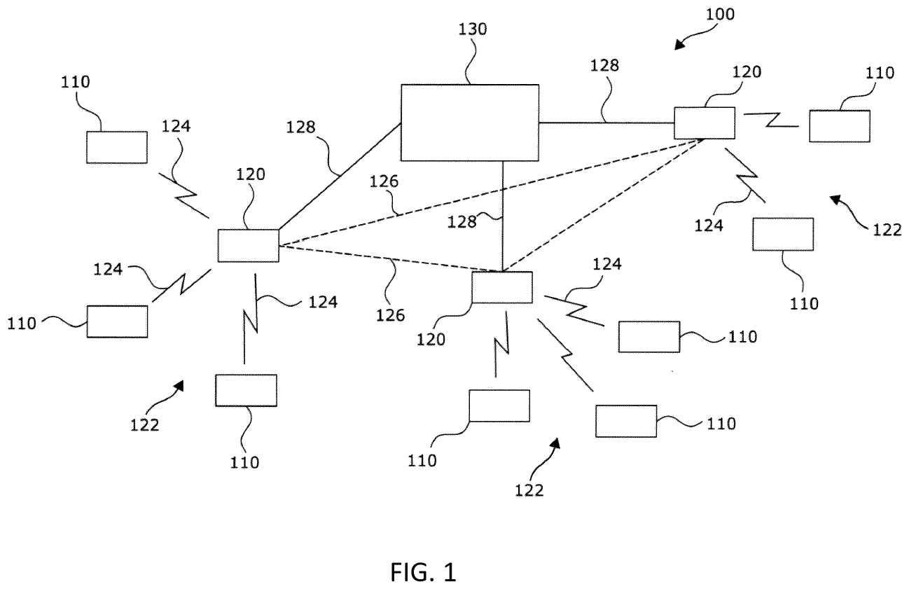

FIG. 1 shows an example network;

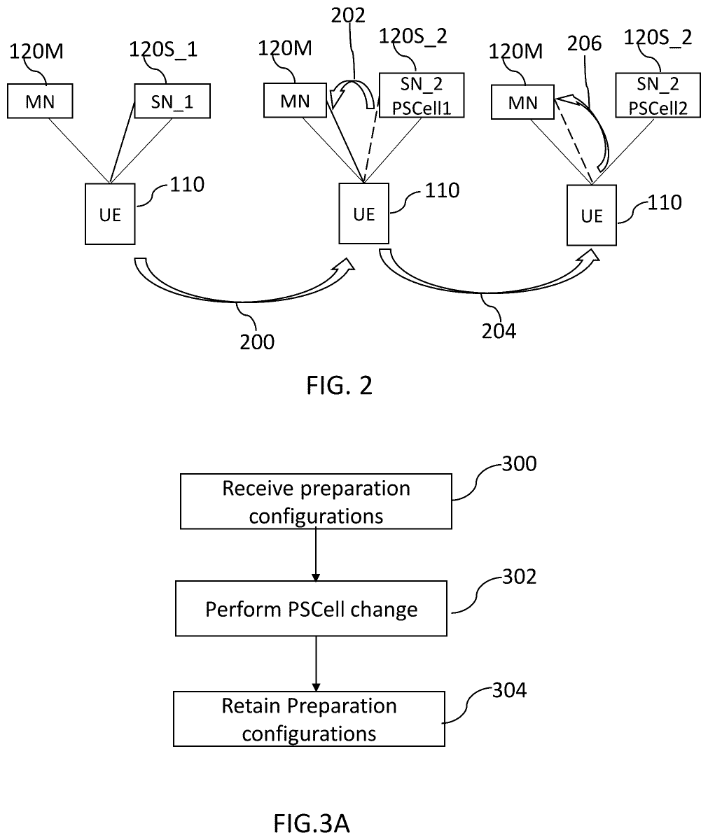

FIG. 2 shows example PSCell changes;

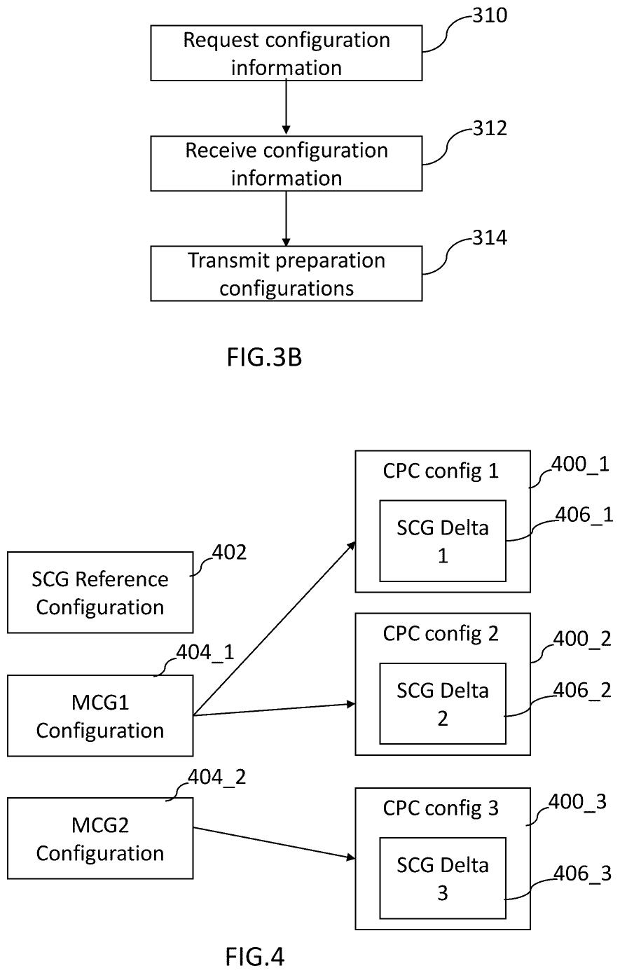

FIGS. 3A and 3B show example methods;

FIG. 4 shows example configurations;

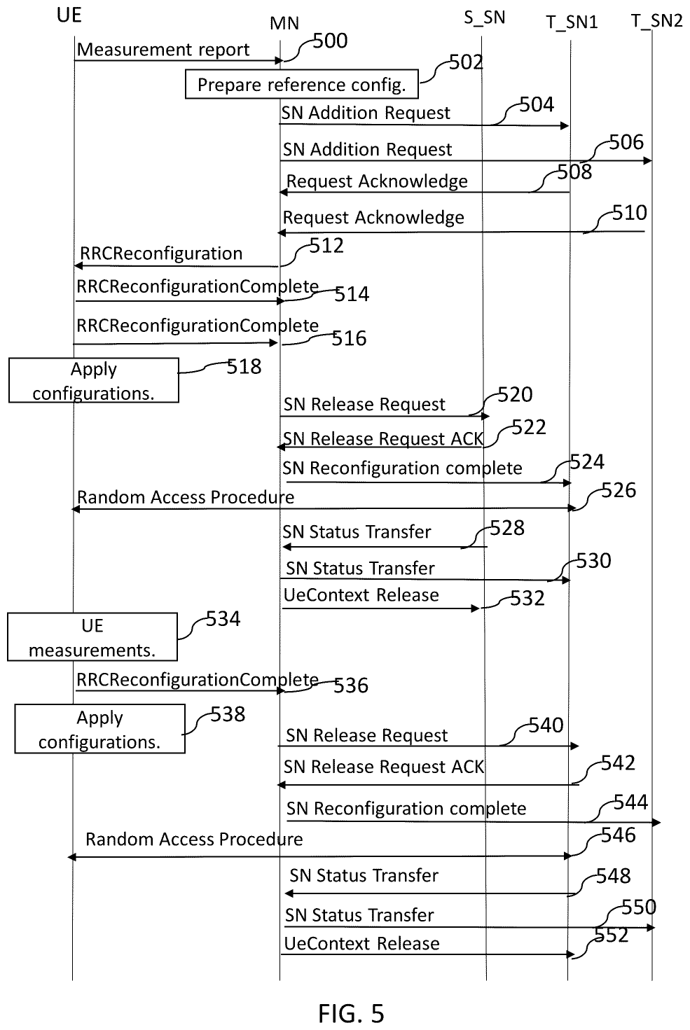

FIG. 5 shows an example signaling procedure;

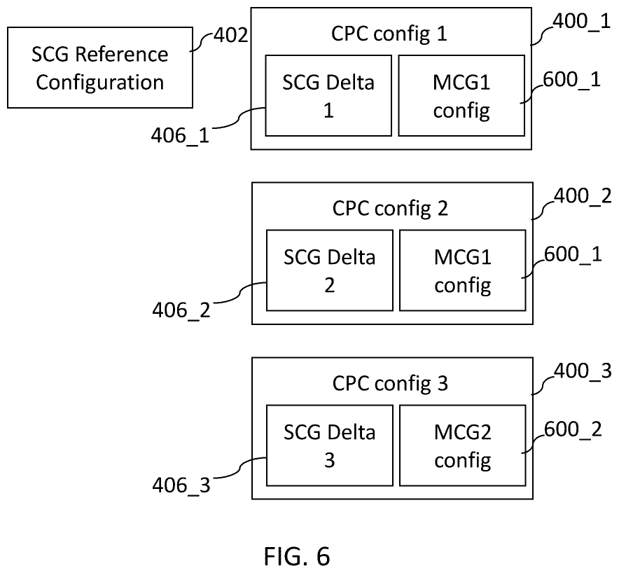

FIG. 6 shows example configurations;

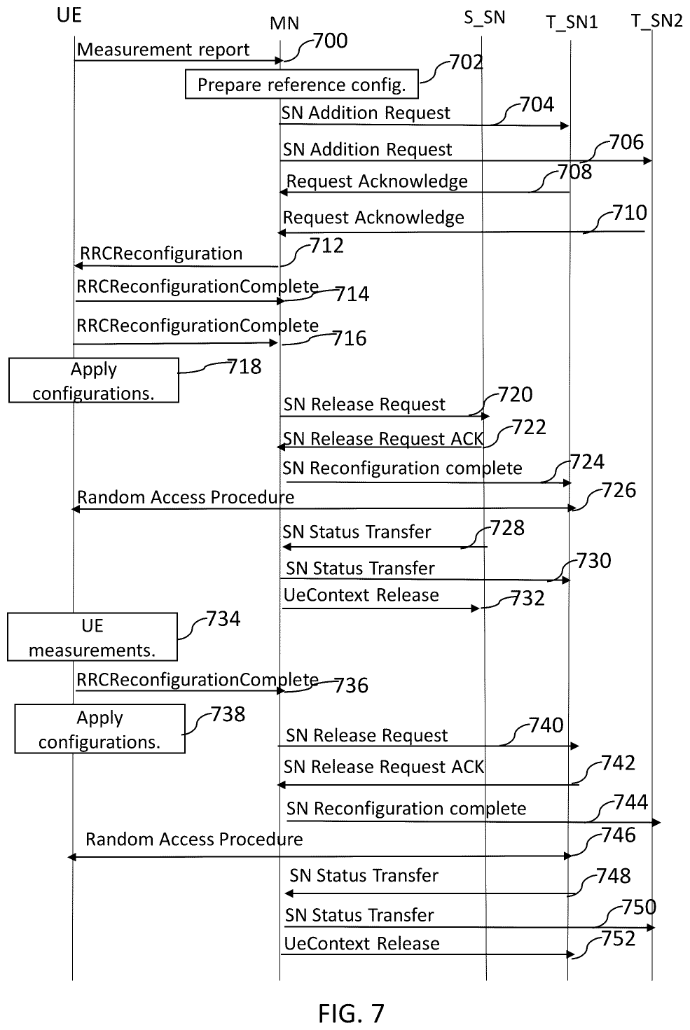

FIG. 7 shows an example signaling procedure;

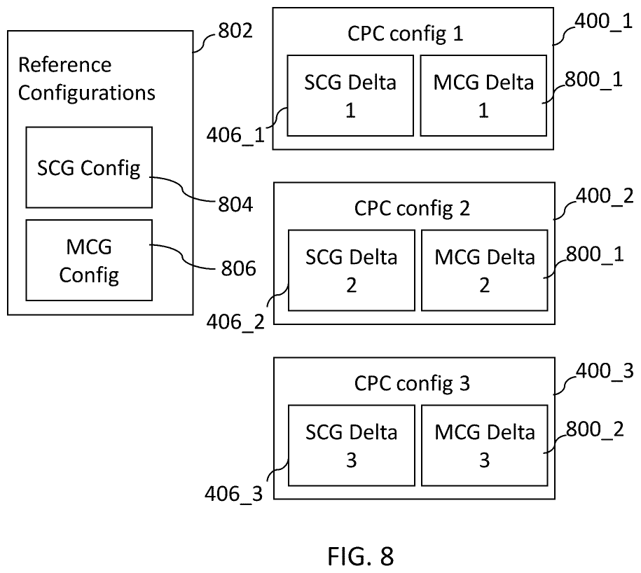

FIG. 8 shows example configurations;

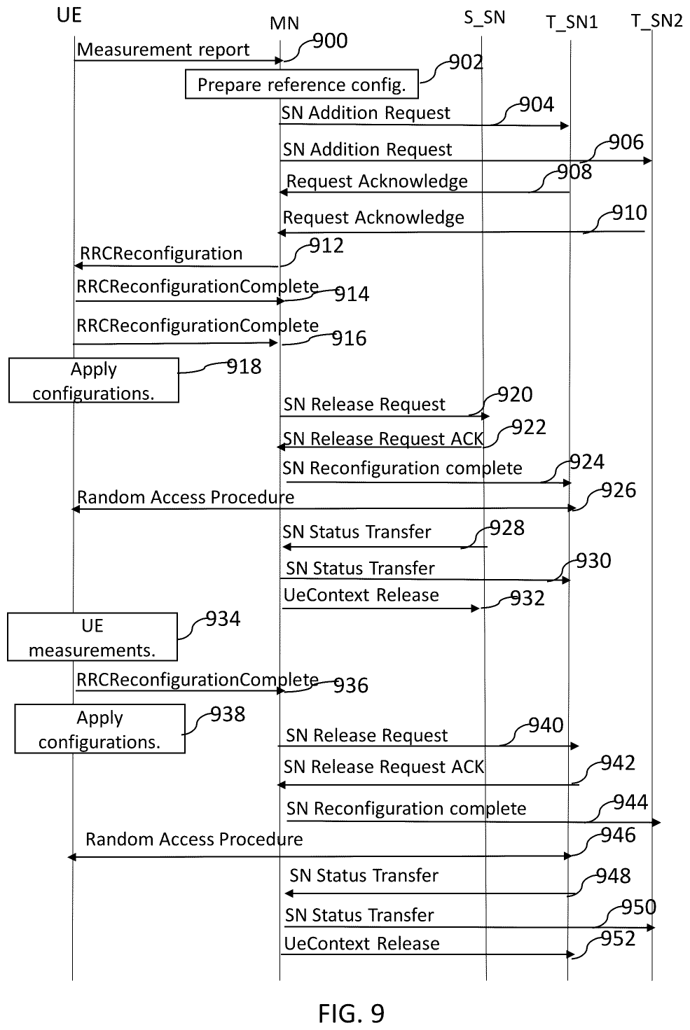

FIG. 9 shows an example signaling procedure; and

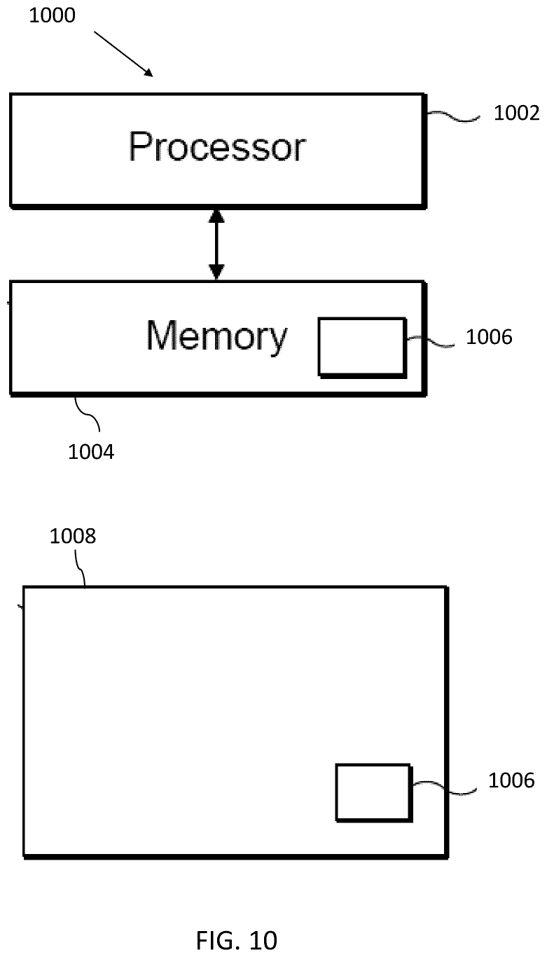

FIG. 10 shows an example controller.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### Definitions

CPA Conditional PSCell Addition
CPAC Conditional PSCell Addition and Change
CPC Conditional PSCell Change
DRB Data Radio Bearer
MAC Medium Access Control
MCG Master Cell Group
MN Master Node
MR Measurement Report
MR-DC Multi-RAT Dual Connectivity
NR-DC New Radio Dual Connectivity
PDCP Packet Data Convergence Protocol
PSCell Primary Secondary Cell
PUCCH Physical Uplink Control Channel
RAT Radio Access Terminology
RLC Radio Link Control
SCG Secondary Cell Group
SCPAC Subsequent CPAC
SN Secondary Node
S-SN Source-SN
T-SN Target-SN

### DETAILED DESCRIPTION

FIG. 1 illustrates an example of a network 100 such as a 5G NR network. The network 100 comprises a plurality of different types of nodes 110, 120, 130. The different types of nodes can comprise terminal nodes 110, and network nodes. The network nodes can comprise serving nodes 120 and core network nodes 130 and/or any other suitable type of apparatus.

The serving nodes 120 can be configured to communicate with the terminal nodes 110. The core network node 130 communicates with the serving nodes 120. In some examples the core network node 130 communicates with the terminal nodes 110.

The core network nodes 130 can, in some examples, communicate with each other. The one or more serving nodes 120 can, in some examples, communicate with each other.

The network 100 can be a cellular network comprising a plurality of cells 122. Each of the cells is served by a serving node 120. In this example, the interface between the terminal node 110 and a serving node 120 defining a cell 122 is a wireless interface 124.

The serving node 120 comprises one or more cellular radio transceivers. The terminal node 110 comprises one or more cellular radio transceivers.

In the example illustrated the cellular network 100 is a third generation Partnership Project (3GPP) network in which the terminal nodes 110 are user equipment (UE) and the serving node 120 can be access nodes such as base stations (gNB).

The term ‘user equipment’ is used to designate mobile equipment comprising a smart card for authentication/encryption etc. such as a Subscriber Identity Module (SIM). In some examples the term ‘user equipment’ is used to designate mobile equipment comprising circuitry embedded as part of the user equipment for authentication/encryption such as software SIM.

The serving node 120 can be a base station. The serving node 120 can be any suitable type of base station. A base station is an access node. The serving node 120 can be a network entity responsible for radio transmission and reception in one or more cells to or from the UE 110. The serving node 120 can be a network element in a Radio Access Network (RAN), or any other suitable type of network.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of work between core network operations and base station operations may vary depending on implementation. Thus, 5G networks architecture may be based on a so-called CU-DU split. One gNB-CU (gNB being an example of the base station or a serving node) may control one or more gNB-DUs. The term ‘gNB’ may correspond in 5G to the eNB in LTE. The gNB-CU (central node) may control a plurality of spatially separated gNB-DUs, acting at least as transmit/receive (Tx/Rx) nodes. In some embodiments, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI (Other System Information) model and the functionalities within each layer.

The core network node 130 can be part of a core network. The core network node 130 can be configured to manage functions relating to connectivity for the UEs 110. For example, the core network node 130 can be configured to manage functions such as connectivity, mobility, authentication, authorization and/or other suitable functions.

In the example of FIG. 1 the core network node 130 is shown as a single entity. In some examples the core network node 130 could be distributed across a plurality of entities. For example, the core network node 130 could be cloud based or distributed in any other suitable manner.

The network 100 can be a 4G or 5G network, for example. It can for example be a New Radio (NR) network that uses gNB as access nodes. New Radio is the 3GPP name for 5G technology. In such cases the serving nodes 120 can comprise gNodeBs (gNBs) 120 configured to provide user plane and control plane protocol terminations towards the UE 110 and/or to perform any other suitable functions. The gNBs 120 are interconnected with each other by means of an X2/Xn interface 126. The gNBs 120 are also connected by means of the N2 interface 128 to the core network nodes 130.

Other types of networks and interfaces could be used in other examples. Other types of networks could comprise next-generation mobile and communication network, for example, a 6G network.

In a Dual Connectivity mode such as New Radio-Dual Connectivity (NR-DC) a UE 110 is connected to a Master Node (MN) and a Secondary node (SN) simultaneously. The MN is a radio access node that provides the control plane connection to the core network. It may be a master gNB or any other suitable type of node. An SN is a radio access node, with no control plane connection to the core network, providing additional resources to the UE 110. It may be a secondary gNB or any other suitable type of node.

Both the MN and the SN can be associated with multiple cells or carriers. The multiple cells or carriers can be referred to as a Master Cell Group (MCG) and a Secondary Cell Group (SCG). An MCG is a group of serving cells associated with the MN. An SCG is a group of serving cells associated with the SN. The respective groups have one primary cell that carries the Physical Uplink Control Channel (PUCCH) and may have one or more secondary cells, The primary cell of the MCG is the PCell and the primary cell of the secondary cell is the PSCell. The respective cell groups can be changed during handover procedures. Other cells of MCG and SCG are called secondary nodes.

FIG. 2 shows example PSCell changes and bearer changes that can occur after PSCell changes. The PSCell changes can comprise a Conditional PSCell change (CPC) procedure or Conditional PSCell Addition and Change (CPAC). The CPC procedure and the CPAC procedure are PSCell change procedures that are executed only when PSCell execution conditions are met. The CPC and the CPAC procedure can occur without a change in the PCell. MN may decide on CPC/CPAC execution conditions.

The example in FIG. 2 shows an Inter-SN PSCell change followed by an Intra-SN PSCell change.

To begin with FIG. 2, the UE 110 is first connected to a first master node 120M and a first secondary node 120S_1. The solid lines between the UE 110 and the respective serving nodes 120 indicate the bearers that are used.

A first PSCell change procedure is performed as indicated by the arrow 200. The first PSCell change 200 can be performed because the UE 110 has moved or for any other suitable reason. After the first PSCell change 200 the UE 110 is connected to a second secondary node 120S_2. The second secondary node 120S_2 has replaced the first secondary node 120S_1. In this example, the first PSCell change 200 is an Inter-SN change because the SN that is connected to the UE 110 changes.

In this case a PSCell change occurs because the UE 110 is now connected to a different SN and corresponding SCG. In this example the second SN 120S_2 has a first PSCell1.

The first PSCell change 200 will result in a change in bearer and MCG configurations. The MCG configurations are the configurations that are used to maintain a link to the MN 120M. The change in bearer is indicated by the arrow 202. The dashed lines indicate the bearers that have been changed. In this case an MCG bearer is added and an SCG bearer is released. The MCG configuration may for example define how load is distributed between the PSCell1 and the MN. As an example, the bearer may be changed from the PSCell1 to the MN because the new PSCell1 cannot handle as much load as the SN_1 (120S_1).

FIG. 2 also shows a second PSCell change that can occur after the first PSCell change.

The second PSCell change is indicated by the arrow 204. The second PSCell change 204 can be performed because the UE 110 has moved or for any other suitable reason.

After the second PSCell change 204 the UE 110 remains connected to the second secondary node 120S_2. However, the PSCell of the SN has changed so the that the second SN 120S_2 is now using a second PSCell2. In this example, the second PSCell change 204 is an Intra-SN change because the SN that is connected to the UE 110 does not change.

The second PSCell can result in a re-mapping of the bearers and MCG configuration that are used as indicated by the arrow 206. However, in this case the remapping of the bearer and the MCG configuration might be unnecessary because there might not be any change in these. In this case the re-mapping could cause an unnecessary interruption due to the resetting of the Medium Access Control (MAC), Radio Link Control (RLC) and Packet Data Convergence Protocol (PDCP). This will also cause unnecessary processing and power consumption at the UE 110 The examples of the disclosure look to reduce these interruptions by avoiding unnecessary remapping of MCG configurations and bearers following CPAC procedures.

FIGS. 3A and 3B show example methods that can be used in examples of the disclosure. The method of FIG. 3A can be implemented by a UE 110 and the method of FIG. 3B can be implemented by an MN 120M.

In the example of FIG. 3A the method comprises, at block 300, receiving, from an MN 120M, preparation configurations for at least a first candidate target PSCell and a second candidate target PSCell.

The preparation configurations can comprise configurations that are to be used for PSCell changes. The preparation configurations can comprise CPC (Conditional PSCell Change) configurations or any other suitable type of configurations.

In examples of the disclosure the received preparation configurations can indicate (or there can be a separate messaging indicating) that the same MCG (Master Cell Group) configuration is shared among two or more PSCells. For example, the received preparation configurations can indicate that the same MCG (Master Cell Group) configuration is shared among at least the first candidate target PSCell and the second candidate target PSCell. In some examples the received preparation configurations can indicate that the same MCG (Master Cell Group) configuration is shared among one or more candidate target PSCells and a source PSCell.

The preparation configurations for respective candidate target PSCells can comprise information relating to an SCG configuration for the corresponding candidate target PSCell. In some examples this information can be provided as a full SCG configuration of the corresponding candidate target PSCell. In such cases the preparation configurations can comprise full SCG configurations for the respective candidate target PSCells.

In some examples, rather than provide a full SCG configuration a delta SCG configuration can be used instead. In such cases the preparation configurations can be associated with a reference SCG configuration and the preparation configurations can comprise a delta SCG configuration for the respective candidate target PSCells. The delta SCG configurations indicate differences between the reference SCG Configuration and the SCG configuration of a corresponding candidate target PSCell. The reference SCG configuration can be provided as part of the preparation configurations or as a separate configuration message to the UE 110.

The preparation configurations for respective candidate target PSCells can also comprise information relating to an MCG configuration for the corresponding candidate target PSCell. The MCG configuration can be used to maintain a link to the MN.

In some examples the information relating to an MCG configuration can be provided as a full MCG configuration of the corresponding candidate target PSCell. In such cases the preparation configurations can comprise full MCG configurations for the respective candidate target PSCells. The same MCG configuration can be used for multiple PSCells. For example, the same MCG configuration can be used for two or more candidate target PSCells. In some examples, the same MCG configuration can be used for a source PSCell and one or more candidate target PSCells.

In some examples rather than provide full MCG and/or SCG configurations within the preparation configurations the UE 110 can be provided with a bitmap that associates the preparation configurations with respective MCG and/or SCG configurations. In such case e.g. the full MCG configuration or several full MCG configurations may be provided separately to the UE 110, and the preparation configurations (e.g. the SCG configurations) may be associated with a corresponding (or to the same) MCG configuration via the bitmap. If there is only one MCG configuration shared by all candidate target PSCells, then the bitmap may not be needed (as all SCG configurations are by default associated to the one and same MCG configuration), or the bitmap may be a null bitmap.

In some examples the preparation configurations can comprise delta MCG configurations. In such cases the preparation configurations can be associated with a reference MCG configuration and the preparation configurations can comprise a delta MCG configuration for the respective candidate target PSCells. The delta MCG configurations indicate differences between the reference MCG Configuration and the MCG configuration of a corresponding candidate target PSCell. The reference configurations can be an MCG configuration that is shared by multiple PSCells. In some examples the reference MCG configuration can comprise the MCG configuration that is applicable to the source PSCell. In such cases the respective delta MCG configurations for PSCells that share the reference configuration would indicate that there are no differences between the reference MCG configuration and the MCG configuration for the respective PSCells. The reference MCG configuration can be provided as part of the preparation configurations or as a separate configuration message to the UE.

In some examples the UE 110 can also receive an indication that the same MCG configuration is shared among two or more PSCells. The two or more PSCells can be a first candidate target PSCell and a second candidate target PSCell. The two or more PSCells can be a source PSCell and one or more candidate target PSCells.

In some examples the indication that the same MCG configuration is shared among two or more PSCells can comprise a delta MCG configuration that indicates no change between the MCG configuration for a first PSCell and the MCG configuration for a second PSCell. The first PSCell can be a first candidate target PSCell and the second PSCell can be a second candidate target PSCell. In some examples first PSCell can be a source PSCell and the second PSCell can be a candidate target PSCell.

The indication that the same MCG configuration is shared among two or more PSCells can be received in any suitable messages. In some examples the indication can be received in a Radio Resource Control (RRC) message such as an RRCReconfiguration message or any other suitable message.

The MCG Configurations and the SCG Configurations can comprise any suitable information or parameters. In some examples the respective parameters can comprise at least one of: Radio Link Control (RLC) parameters, Medium Access Control (MAC) parameters, Packet Data Convergence Protocol (PDCP) parameters or any other suitable information or parameters.

At block 302 the method comprises performing a PSCell change from a source PSCell to the first candidate target PSCell.

At block 304 the method comprises retaining the preparation configurations after the PSCell change, wherein the PSCell change is performed without a PCell change. The retaining of the preparation configurations can comprise storing the preparation configurations so that they can be accessed and used for further PSCell changes. In some examples the preparation configurations that comprise shared MCG configurations are stored.

In some examples the UE 110 can perform a further PSCell change. For example, the UE 110 can perform a PSCell change from the first candidate PSCell to the second candidate PSCell. In such examples the UE 110 can access the retained preparation configurations to enable the same MCG configuration to be used for the first candidate target PSCell and the second candidate target PSCell. Thus, there is then no need to remap the existing bearers for the MCG (MN/PCell).

The retaining of the preparation configurations helps to avoid unnecessary interruptions caused be resetting of the configurations. This can also help to reduce the signalling needed as the MN does not need to resend the preparation configurations.

FIG. 3B shows an example method that can be performed by an MN 120M. The UE 110 that performs the method of FIG. 3A can be connected to an MN 120M that performs the method of FIG. 3B.

In the example of FIG. 3B the method comprises, at block 310, requesting configuration information from one or more candidate target SNs. The one or more candidate target SNs can comprise at least a first candidate target secondary node associated with a first candidate target PSCell and at least a second candidate target secondary node associated with a second candidate target PSCell.

The requests can be made using any suitable messages such as an SN addition request.

At block 312 the method comprises receiving the requested configuration information. The requested information can be received using any suitable messages such as SN addition request acknowledgements. In an embodiment the received configuration information can comprise at least part of the above-mentioned preparation configurations, or in general information on which the preparation configurations are based on.

At block 314 the method comprises transmitting, to a UE 110, preparation configurations for at least the first candidate target PSCell and the second candidate target PSCell. The same MCG configuration is shared among two or more PSCells.

For example, the same MCG configuration can be shared among at least the first candidate target PSCell and the second candidate target PSCell. In some examples the same MCG configuration can be shared between a source PSCell and one or more candidate target PSCells.

The preparation configurations can inform the UE 110 that the same MCG configuration is shared among two or more PSCells.

FIG. 4 schematically illustrates example preparation configurations 400 that can be used in examples of the disclosure. These preparation configurations 400 can inform the UE 110 that the same MCG configuration is applicable to multiple PSCells.

In the example of FIG. 4 three preparation configurations 400 are shown. In this example the preparation configurations 400 are CPC configurations. Other types of configurations can be used in other examples of the disclosure.

The different preparation configurations 400 are for different PSCells. The different PSCells can be associated with different SNs. In the example of FIG. 4 the first preparation configuration 400_1 is for a first candidate target PSCell, the second preparation configuration 400_2 is for a second candidate target PSCell and the third preparation configuration 400_3 is for a third candidate target PSCell. Other numbers of preparation configurations 400 and corresponding PSCells can be used in other examples.

The respective preparation configurations 400 can comprise information indicative of an MCG configuration and information indicative of an SCG configuration for the corresponding PSCells.

In the example of FIG. 4 a bitmap, or another suitable means, can be used to associate the respective preparation configurations 400 with the corresponding MCG configurations 404. In this illustrative example the bitmap can refer to a first MCG configuration 404_1 and a second MCG configurations MCG 404_2. The preparation configurations 400 indicate which of these MCG configurations are applicable for the corresponding PSCells. In this example the first preparation configuration 400_1 is associated with the first MCG configuration 404_1 and the second preparation configuration 400_2 is also associated with the first MCG configuration 404_1. This indicates that the first MCG configuration 404_1 is shared between multiple PSCells. In this example the third preparation configuration 400_3 is associated with the second MCG configuration 404_2. This indicates that the MCG configuration can be different for at least some of the PSCells.

In the example of FIG. 4 the information indicative of an SCG configuration can comprise a delta SCG configuration 406. In this example the preparation configurations 400 are associated with a reference SCG configuration 402. The reference SCG configuration 402 can comprise a set of reference parameters for an SCG configuration. The reference SCG configuration 402 can comprise the SCG parameters for a source PSCell.

The delta SCG configurations 406 comprise the differences between the reference SCG configuration 402 and the SCG configuration that is applicable for the corresponding PSCell. In the example of FIG. 4 a first delta SCG configuration 406_1 is comprised in the first preparation configuration 400_1, a second delta SCG configuration 406_2 is comprised in the second preparation configuration 400_2, and a third delta SCG configuration 406_3 is comprised in the third preparation configuration 400_3.

The MCG configurations and SCG configurations can comprise RLC parameters, MAC parameters, PDCP parameters and/or any other suitable information that can be used to remap or reset bearers when a PSCell change occurs.

FIG. 5 shows an example signaling procedure that can be used in examples of the disclosure. The example preparation configurations 400 shown in FIG. 4 can be used in the example of FIG. 5.

At block 500 the UE 110 transmits a Measurement Report (MR) to the MN 120M.

At block 502 the MN 120M prepares the reference SCG configuration 402. The reference SCG configuration 402 can be the configuration of the source PSCell, or some other reference SCG configuration. The reference SCG configuration 402 provides the reference to which the delta SCG configurations can be compared. The MN 120M can also initiate the CPAC procedure. This can be an Inter SN CPAC procedure that involves a change in SN. This can correspond to the first PSCell change as shown in FIG. 2. The inter SN CPAC procedure can be initiated based on the received MR.

At block 504 and 506 the MN 120M sends a request for configuration information to the target SNs. An SN addition request can be used to request the configuration information. At block 504 the MN 120M sends an SN addition request to a first target SN and at block 506 the MN 120M sends an SN addition request to a second target SN. In the example of FIG. 5 only two target SNs are shown but the MN 120M could send the request for configuration information to any number of target SNs.

The respective SN addition requests can comprise an indication of the MCG configurations. If the preparation configurations 400 shown in FIG. 4 are used then the first MCG configuration 404_1 would be indicated for the first two SNs and the second MCG configuration 404-2 would be indicated for a third SN.

The respective SN addition requests can also comprise an indication of the reference SCG configuration 402. The same reference SCG configuration 402 can be sent to each target SN. The reference SCG configuration 402 can be used by the respective target SNs to determine a delta SCG Configuration. The reference SCG configuration 402 can be the configuration for the source PSCell. Alternatively, the reference SCG configuration can be otherwise commonly known by the candidate target SNs (providing the candidate target PSCells).

At blocks 508 and 510 the MN 120M receives responses to the requests for configuration information. The received response can comprise the requested configuration information. The requested information can be received using any suitable messages such as SN addition request acknowledgements.

At block 508 the MN 120M receives the request acknowledgement from the first target SN and at block 510 the MN 120M receives the request acknowledgement from the second target SN. The request acknowledgments can comprise the delta SCG configurations 406 for the PSCells of the respective target SNs. In the example of FIG. 5 the MN 120M is shown to receive configuration information from two target SNs however the MN 120M could receive configuration information to any number of target SNs.

At block 512 the MN 120M sends an RRCReconfiguration message to the UE 110. The RRCReconfiguration message may comprise the MN RRC reconfiguration information and also the SN conditional RRC reconfigurations. As an example, the RRC reconfiguration message may comprise the reference SCG configuration, the delta SCG configurations and relevant MCG configurations(s). These, or subset of these, may be referred to as the preparation configurations.

The RRCReconfiguration message can comprise an indication that the same MCG configuration can be shared among multiple PSCells. The indication can be made using the preparation configurations 400 or any other suitable means. If the example preparation configurations 400 of FIG. 4 are used, then the same MCG configuration 404_1 is associated with both the first candidate target PSCell and the second candidate target PSCell. This indicates that the same MCG configuration 404_1 is shared among at least the first candidate PSCell and the second candidate target PSCell.

The SCG configuration can also be transmitted in the RRCReconfiguration message. The SCG configuration information can comprise the reference SCG configuration 402 and the delta SCG configurations 406 for each of the candidate PSCells.

At block 514 UE 110 responds to the RRCReconfiguration message by sending an RRCReconfiguration complete message to the MN 120M.

If the execution conditions are satisfied for the first PSCell then, at block 516 the UE 110 sends an RRCReconfiguration complete message to the MN 120M. This RRCReconfiguration complete message indicates that the PSCell is to be changed from the source PSCell to the first candidate target PSCell.

At block 518 the UE 110 applies the MCG configurations and the SCG configurations for the first candidate target PSCell as indicated in the received preparation configurations 400. In this case the first MCG configuration 404_1 would be applied for the first candidate target PSCell. The first SCG configuration would be applied by accessing the first delta SCG file 406_1 and applying the differences indicated therein to the reference SCG configuration 402. It is noted that instead of sending the reference SCG configuration and the delta SCG configurations to the UE 110, the MN 120M can determine the full SCG configurations based on the reference SCG configuration and the delta SCG configurations for each PSCell, and provide the full SCG configurations to the UE 110 as the preparation configurations 400. in some examples, if the UE 110 knows the reference configuration, then the MN 120M may not need to send that to the UE 110 but only the delta SCG configurations to the UE 110.

At block 520 the MN 120M sends an SN release request to the Source SN and at block 522 the Source SN responds to the SN release Request by sending and SN Release request acknowledgement to the MN 120M.

At block 524 the MN 120M sends an SN Reconfiguration Complete message to the first target SN that contains the first candidate target PSCell.

At block 526 the UE 110 performs the Random Access Procedure towards the first candidate target PSCell of the first target SN.

At block 528 the Source SN sends a status transfer to the MN 120M to enable data forwarding and at block 530 the MN 120M sends the SN status transfer to the first target SN for data forwarding. At block 532 the MN 120M send the UeContextRelease to the Source SN.

Following the PSCell change the UE 110 retains the received preparation configurations. The preparation configurations can be retained so that they can be accessed and used for subsequent PSCell changes.

At block 534 the UE 110 continues with measurements and checking for CPC conditions. If the UE 110 detects that execution conditions are satisfied for a second candidate target PSCell then, at block 536, the UE 110 sends RRCReconfigurationComplete to MN 120M. This message indicates that the PSCell is to be changed to from the first candidate target PSCell to the second candidate target PSCell.

Following the transmission of the RRCReconfigurationComplete message the UE 110 applies, at block 534, the MCG configurations and the SCG configurations for the second candidate target PSCell. The UE 110 can apply the MCG configurations and the SCG configurations for second candidate target PSCell by accessing the preparation configurations 400 that have been retained. The MN 120M does not need to send further preparation configurations 400.

In this case the retained preparation configurations 400 indicate that the same MCG configuration 404_1 is shared for both the first candidate target PSCell and the second candidate target PSCell. Therefore, the UE 110 does not reset the MCG configurations for the PSCell change to the second candidate target PSCell. This avoids unnecessarily resetting the MCG configurations.

The second SCG configuration would be applied by accessing the delta SCG configuration 406_2 for the second candidate target PSCell and applying the differences indicated therein to the reference SCG configuration 402.

At block 540 the MN 120M sends an SN release request to the first target SN and at block 542 the first target SN responds to the SN release Request by sending an SN Release request acknowledgement to the MN 120M.

At block 544 the MN 120M sends an SN Reconfiguration Complete message to the second target SN that contains the second candidate target PSCell.

At block 546 the UE 110 performs the Random Access Procedure towards PSCell2 of the second target SN.

At block 548 the first target SN sends a status transfer to the MN 120M to enable data forwarding and at block 550 the MN 120M sends the SN status transfer to the second target SN for data forwarding. At block 552 the MN 120M sends the UeContextRelease to the first target SN.

FIG. 6 schematically illustrates another set of example preparation configurations 400 that can be used in examples of the disclosure. These preparation configurations 400 can also inform the UE 110 that the same MCG configuration is applicable to multiple PSCells.

In the example of FIG. 6 three preparation configurations 400 are shown. In this example the preparation configurations 400 are CPC configurations. Other types of configurations can be used in other examples of the disclosure.

The different preparation configurations 400 are for different PSCells. The different PSCells can be associated with different SNs. In the example of FIG. 6 the first preparation configuration 400_1 is for a first candidate target PSCell, the second preparation configuration 400_2 is for a second candidate target PSCell and the third preparation configuration 400_3 is for a third candidate target PSCell. Other numbers of preparation configurations 400 and corresponding PSCells can be used in other examples.

The respective preparation configurations 400 can comprise information indicative of an MCG configuration and information indicative of an SCG configuration for the corresponding PSCells.

In the example of FIG. 6 the preparation configurations 400 comprise a full MCG configuration 600 for the respective PSCells.

In this example the first preparation configuration 400_1 comprises the first MCG configuration 600_1 and the second preparation configuration 400_2 also comprises the first MCG configuration 600_1. This indicates that the first MCG configuration 600_1 is the same in multiple PSCells. In this example the third preparation configuration 400_3 comprises the second MCG configuration 600_2. This indicates that the MCG configuration can be different for at least some of the PSCells.

In the example of FIG. 6 the information indicative of an SCG configuration can comprise a delta SCG configuration 406 and the preparation configurations 400 are associated with a reference SCG configuration 402. The delta SCG configurations and the reference SCG configuration 402 can be as described in relation to FIG. 4.

The MCG configurations and SCG configurations can comprise RLC parameters, MAC parameters, PDCP parameters and/or any other suitable information that can be used to remap or reset bearers when a PSCell change occurs.

FIG. 7 shows an example signaling procedure that can be used in examples of the disclosure. The example preparation configurations 400 shown in FIG. 6 can be used in the example of FIG. 7.

At block 700 the UE 110 transmits a Measurement Report (MR) to the MN 120M.

At block 702 the MN 120M prepares the reference SCG configuration 402. The reference SCG configuration 402 can be the configuration of the source PSCell, or any predefined reference configuration. The reference SCG configuration 402 provides the reference to which the delta SCG configurations can be compared. The MN 120M can also initiate the CPAC procedure. This can be an Inter SN CPAC procedure that involves a change in SN. This can correspond to the first PSCell change as shown in FIG. 2. The inter SN CPAC procedure can be initiated based on the received MR.

At block 704 and 706 the MN 120M sends a request for configuration information to the target SNs. An SN addition request can be used to request the configuration information. At block 704 the MN 120M sends an SN addition request to a first target SN and at block 706 the MN 120M sends an SN addition request to a second target SN. In the example of FIG. 7 only two target SNs are shown but the MN 120M could send the request for configuration information to any number of target SNs.

The respective SN addition requests can comprise an indication of the MCG configurations. If the preparation configurations 400 shown in FIG. 6 are used then the first MCG configuration 600_1 would be indicated for the first two SNs and a second MCG configuration 600_2 would be indicated for a third SN.

The respective SN addition requests can comprise an indication of the reference SCG configuration 402, unless it is already known to the respective PSCells. The same reference SCG configuration 402 can be sent to each target SN. The reference SCG configuration 402 can be used by the respective target SNs to determine a delta SCG Configuration. The reference SCG configuration 402 can be the configuration for the source PSCell.

At blocks 708 and 710 the MN 120M receives responses to the requests for configuration information. The received response can comprise the requested configuration information, such as the delta SCG configurations. The requested information can be received using any suitable messages such as SN addition request acknowledgements.

At block 708 the MN 120M receives the request acknowledgement from the first target SN and at block 710 the MN 120M receives the request acknowledgement from the second target SN. The request acknowledgments can comprise the delta SCG configurations 406 for the PSCells of the respective target SNs. In the example of FIG. 7 the MN 120M is shown to receive configuration information from two target SNs however the MN 120M could receive configuration information to any number of target SNs.

At block 712 the MN 120M sends an RRCReconfiguration message to the UE 110. The RRCReconfiguration message comprises the MN RRC reconfiguration information and also the SN conditional RRC reconfigurations. As an example, the RRC reconfiguration message may comprise the reference SCG configuration, the delta SCG configurations and relevant MCG configurations(s). These, or subset of these, may be referred to as the preparation configurations.

The RRCReconfiguration message can comprise an indication that the same MCG configuration can be shared among multiple PSCells. The indication can be made using the preparation configurations 400 or any other suitable means. If the example preparation configurations 400 of FIG. 6 are used, then the same first MCG configuration 600_1 is associated with both the first candidate target PSCell and the second candidate target PSCell. This indicates that the same MCG configuration 6001 is present in at least the first candidate PSCell and the second candidate target PSCell.

The SCG configuration can also be transmitted in the RRCReconfiguration message. The SCG configuration information can comprise a reference SCG configuration 402 and the delta SCG configurations 406 for each of the candidate PSCells. It is noted that instead of sending the reference SCG configuration and the delta SCG configurations to the UE 110, the MN 120M can determine the full SCG configurations based on the reference SCG configuration and the delta SCG configurations for each PSCell, and provide the full SCG configurations to the UE 110 as the preparation configurations. As yet one embodiment, if the UE 110 knows the reference configuration, then the MN 120M may not need to send that to the UE 110 but only the delta SCG configurations to the UE 110.

At block 714 UE 110 responds to the RRCReconfiguration message by sending an RRCReconfiguration complete message to the MN 120M.

If the execution conditions are satisfied for the first candidate target PSCell then, at block 716 the UE 110 sends an RRCReconfiguration complete message to the MN 120M. This RRCReconfiguration complete message indicates that the PSCell is to be changed from the source PSCell to the first candidate target PSCell.

At block 718 the UE 110 applies the MCG configurations and the SCG configurations for the first candidate target PSCell as indicated in the received preparation configurations 400. In this case the first MCG configuration 600_1 would be applied for the first candidate target PSCell. The first SCG configuration would be applied e.g. by accessing the first delta SCG file 406_1 and applying the differences indicated therein to the reference SCG configuration 402.

At block 720 the MN 120M sends an SN release request to the Source SN and at block 722 the Source SN responds to the SN release Request by sending and SN Release request acknowledgement to the MN 120M.

At block 724 the MN 120M sends an SN Reconfiguration Complete message to the first target SN that contains the first candidate target PSCell.

At block 726 the UE 110 performs the Random Access Procedure towards the first candidate target PSCell of the first target SN.

At block 728 the Source SN sends a status transfer to the MN 120M to enable data forwarding and at block 730 the MN 120M sends the SN status transfer to the first target SN for data forwarding. At block 732 the MN 120M sends the UeContextRelease to the Source SN.

Following the PSCell change the UE 110 retains the received preparation configurations. The preparation configurations can be retained so that they can be accessed and used for subsequent PSCell changes.

At block 734 the UE 110 continues with measurements and checking for CPC conditions. If the UE 110 detects that execution conditions are satisfied for a second candidate target PSCell then, at block 736, the UE 110 sends RRCReconfigurationComplete to MN 120M. This message indicates that the PSCell is to be changed to from the first candidate target PSCell to the second candidate target PSCell.

Following the transmission of the RRCReconfigurationComplete message the UE 110 applies, at block 734, the MCG configurations and the SCG configurations for the second candidate target PSCell. The UE 110 can apply the MCG configurations and the SCG configurations for second candidate target PSCell by accessing the preparation configurations 400 that have been retained. The MN 120M does not need to send further preparation configurations 400.

In this case the retained preparation configurations 400 indicate that the same MCG configuration 600_1 is the same for both first candidate target PSCell and the second candidate target PSCell. Therefore, the UE 110 does not reset the MCG configurations for the PSCell change to the second candidate target PSCell. This avoids unnecessarily resetting the MCG configurations.

The second SCG configuration would be applied by delta SCG configuration 406_2 for the second candidate target PSCell and applying the differences indicated therein to the reference SCG configuration 402.

At block 740 the MN 120M sends an SN release request to the first target SN and at block 742 the first target SN responds to the SN release Request by sending an SN Release request acknowledgement to the MN 120M.

At block 744 the MN 120M sends an SN Reconfiguration Complete message to the second target SN that contains the second candidate target PSCell.

At block 746 the UE 110 performs the Random Access Procedure towards PSCell2 of the second target SN.

At block 748 the first target SN sends a status transfer to the MN 120M to enable data forwarding and at block 750 the MN 120M sends the SN status transfer to the second target SN for data forwarding. At block 752 the MN 120M sends the UeContextRelease to the first target SN.

FIG. 8 schematically illustrates another set of example preparation configurations 400 that can be used in examples of the disclosure. These preparation configurations 400 can also inform the UE 110 that the same MCG configuration is applicable to multiple PSCells. In this case the preparation configurations 400 can also indicate that one or more of the MCG configurations is the same as the configurations for the source PSCell.

In the example of FIG. 8 three preparation configurations 400 are shown. In this example the preparation configurations 400 are CPC configurations. Other types of configurations can be used in other examples of the disclosure.

The different preparation configurations 400 are for different PSCells. The different PSCells can be associated with different SNs. In the example of FIG. 8 the first preparation configuration 400_1 is for a first candidate target PSCell, the second preparation configuration 400_2 is for a second candidate target PSCell and the third preparation configuration 400_3 is for a third candidate target PSCell. Other numbers of preparation configurations 400 and corresponding PSCells can be used in other examples.

The respective preparation configurations 400 can comprise information indicative of an MCG configuration and information indicative of an SCG configuration for the corresponding PSCells.

In the example of FIG. 8 the information indicative of an MCG configuration can comprise a delta MCG configuration 800. In this example the preparation configurations 400 are associated with a reference configuration 802. The reference configuration 802 comprises a reference MCG configuration 806. The reference MCG configuration 806 can comprise a set of reference parameters for an MCG configuration. The reference MCG configuration 806 can comprise the MCG parameters for a source PSCell.

The delta MCG configurations 800 comprise the differences between the reference MCG configuration 806 and the MCG configuration that is applicable for the corresponding PSCell. In the example of FIG. 8 a first delta MCG configuration 800_1 is used for the first preparation configuration 400_1, a second delta MCG configuration 800_2 is used for the second preparation configuration 400_2, and a third delta MCG configuration 800_3 is used for the third preparation configuration 400_3.

The respective delta MCG configurations 800 can be the different to each other or one or more them can be the same. If one or more of the delta MCG configurations are the same then this indicates that the same MCG configurations are shared by multiple PSCells.

In some examples one or more of the delta MCG configurations 800 can indicate that there is no difference between the MCG configurations of the corresponding candidate target PSCell and the reference MCG configuration 806. This may indicate that the same MCG configuration can be applied for a source PSCell and for one or more candidate target PSCells.

The preparation configurations 400 also comprise information indicative of an SCG configuration. The information indicative of an SCG configuration can comprise a delta SCG configuration 406. In this example the reference configurations 802 also comprises a reference SCG configuration 804. The reference SCG configuration 804 can comprise a set of reference parameters for an SCG configuration. The reference SCG configuration 804 can comprise the SCG parameters for a source PSCell.

The delta SCG configurations 406 comprise the differences between the reference SCG configuration 804 and the SCG configuration that is applicable for the corresponding PSCell. In the example of FIG. 8 a first delta SCG configuration 406_1 is used for the first preparation configuration 400_1, a second delta SCG configuration 406_2 is used for the second preparation configuration 400_2, and a third delta SCG configuration 406_3 is used for the third preparation configuration 400_3.

The MCG configurations and SCG configurations can comprise RLC parameters, MAC parameters, PDCP parameters and/or any other suitable information that can be used to remap or reset bearers when a PSCell change occurs.

FIG. 9 shows an example signaling procedure that can be used in examples of the disclosure. The example preparation configurations 400 shown in FIG. 8 can be used in the example of FIG. 9.

At block 900 the UE 110 transmits a Measurement Report (MR) to the MN 120M.

At block 902 the MN 120M prepares the reference configuration 802. The reference configuration 802 can comprise the reference MCG configuration 806 and the reference SCG configuration 804. This provides the references to which the delta configurations can be compared. The MN 120M can also initiate the CPAC procedure. This can be an Inter SN CPAC procedure that involves a change in SN. This can correspond to the first PSCell change as shown in FIG. 2. The inter SN CPAC procedure can be initiated based on the received MR.

At block 904 and 906 the MN 120M sends a request for configuration information to the target SNs. An SN addition request can be used to request the configuration information, such as delta information with respect to the above-mentioned reference configurations. At block 904 the MN 120M sends an SN addition request to a first target SN and at block 906 the MN 120M sends an SN addition request to a second target SN. In the example of FIG. 9 only two target SNs are shown but the MN 120M could send the request for configuration information to any number of target SNs.

The respective SN addition requests can also comprise an indication of the reference SCG configuration 804 and an indication of the reference MCG configuration 806, if not otherwise known by the relevant PSCells. The reference configurations can be used by the respective target SNs to determine a delta SCG Configuration 406 and a delta MCG configuration 800.

At blocks 908 and 910 the MN 120M receives responses to the requests for configuration information. The received response can comprise the requested configuration information, such as delta information with respect to the above-mentioned reference configurations. The requested information can be received using any suitable messages such as SN addition request acknowledgements.

At block 908 the MN 120M receives the request acknowledgement from the first target SN and at block 910 the MN 120M receives the request acknowledgement from the second target SN. The request acknowledgments can comprise the delta SCG configurations 406 and the delta MCG configuration 800 for the PSCells of the respective target SNs. In the example of FIG. 9 the MN 120M is shown to receive configuration information from two target SNs however the MN 120M could receive configuration information to any number of target SNs.

At block 912 the MN 120M sends an RRCReconfiguration message to the UE 110. The RRCReconfiguration message comprises the MN RRC reconfiguration information and also the SN conditional RRC reconfigurations.

The RRCReconfiguration message can comprise an indication that the same MCG configuration can be applied to multiple PSCells. The indication can be made using the preparation configurations 400 or any other suitable means. If the example preparation configurations 400 of FIG. 8 are used, then a delta MCG configuration that indicates no difference implies that the MCG configuration for that PSCell is the same as the reference MCG configuration 806. In some examples the same delta MCG configuration can be used in preparation configurations 400 for multiple different PSCells. This can indicate that the same MCG configuration is shared by the multiple different PSCells.

The SCG configuration can also be transmitted in the RRCReconfiguration message. The SCG configuration information can comprise a reference SCG configuration 806 and the delta SCG configurations 406 for each of the candidate PSCells. As an example, the RRC reconfiguration message may comprise the reference SCG configuration, the delta SCG configurations, the reference MCG configuration, and the delta MCG configurations. These, or subset of these, may be referred to as the preparation configurations. It is noted that instead of sending the reference configurations and the delta configurations to the UE 110, the MN 120M can determine the full configurations based on the reference configurations and the delta configurations for each PSCell, and provide the full configurations to the UE 110 as the preparation configurations. As yet one embodiment, if the UE 110 knows the reference configurations, then the MN 120M may not need to send that to the UE 110 but only the delta configurations to the UE 110.

At block 914 UE 110 responds to the RRCReconfiguration message by sending an RRCReconfiguration complete message to the MN 120M.

If the execution conditions are satisfied for the first candidate target PSCell then, at block 916 the UE 110 sends an RRCReconfiguration complete message to the MN 120M. This RRCReconfiguration complete message indicates that the PSCell is to be changed from the source PSCell to the first candidate target PSCell.

At block 918 the UE 110 applies the MCG configurations and the SCG configurations for the first candidate target PSCell as indicated in the received preparation configurations 400. In this case the first MCG configuration would be applied for the first candidate target PSCell. The first MCG configuration can be applied e.g. by accessing the first delta MCG configuration 800_1 and applying any changes indicated therein to the reference MCG configuration 806. The first SCG configuration can be applied e.g. by accessing the first delta SCG configuration 406_1 and applying the changes indicated therein to the reference SCG configuration 804. If the first delta MCG configuration 8001 indicates that there are no differences to the reference MCG configuration 806 then the MCG configurations of the source PSCell may be applied and there is no need for remapping or resetting of the bearers.

At block 920 the MN 120M sends an SN release request to the Source SN and at block 922 the Source SN responds to the SN release Request by sending and SN Release request acknowledgement to the MN 120M.

At block 924 the MN 120M sends an SN Reconfiguration Complete message to the first target SN that contains the first candidate target PSCell.

At block 926 the UE 110 performs the Random Access Procedure towards PSCell1 of the first target SN.

At block 928 the Source SN sends a status transfer to the MN 120M to enable data forwarding and at block 930 the MN 120M sends the SN status transfer to the first target SN for data forwarding. At block 932 the MN 120M sends the UeContextRelease to the Source SN.

Following the PSCell change the UE 110 retains the received preparation configurations. The preparation configurations can be retained so that they can be accessed and used for subsequent PSCell changes.

At block 934 the UE 110 continues with measurements and checking for CPC conditions. If the UE 110 detects that execution conditions are satisfied for a second candidate target PSCell then, at block 936, the UE 110 sends RRCReconfigurationComplete to the MN 120M. This message indicates that the PSCell is to be changed to from the first candidate target PSCell to the second candidate target PSCell.

Following the transmission of the RRCReconfigurationComplete message the UE 110 applies, at block 934, the MCG configurations and the SCG configurations for the second candidate target PSCell. The UE 110 can apply the MCG configurations and the SCG configurations for second candidate target PSCell by accessing the preparation configurations 400 that have been retained. The MN 120M does not need to send further preparation configurations 400.

The MCG configuration for the second candidate target PSCell can be applied e.g. by accessing the second delta MCG configuration 800_2 and applying any differences indicated therein to the reference MCG configuration 806. Similarly, the SCG configuration for the second candidate target PSCell can be applied e.g. by accessing the second delta SCG configuration 406_2 and applying any differences indicated therein to the reference SCG configuration 804. If the second delta MCG configuration 800_2 indicates that there are no changes then the reference MCG configurations can be applied and there is no need for remapping or resetting of the bearers.

At block 940 the MN 120M sends an SN release request to the first target SN and at block 942 the first target SN responds to the SN release Request by sending an SN Release request acknowledgement to the MN 120M.

At block 944 the MN 120M sends an SN Reconfiguration Complete message to the second target SN that contains the second candidate target PSCell.

At block 946 the UE 110 performs the Random Access Procedure towards PSCell2 of the second target SN.

At block 948 the first target SN sends a status transfer to the MN 120M to enable data forwarding and at block 950 the MN 120M sends the SN status transfer to the second target SN for data forwarding. At block 952 the MN 120M send the UeContextRelease to the first target SN.

FIG. 10 illustrates an example controller 1000. The controller 1000 could be provided within an entity such as a UE 110 or a MN 120M or any other suitable apparatus, or the controller can be the UE 110 or the MN 120M, for example. Implementation of the controller 1000 may be as controller circuitry. The controller 1000 may be implemented in hardware alone, have certain aspects in software including firmware alone or can be a combination of hardware and software (including firmware).

As illustrated in FIG. 10 the controller 1000 can be implemented using instructions that enable hardware functionality, for example, by using executable instructions of a computer program 1006 in a general-purpose or special-purpose processor 1002 that may be stored on a computer readable storage medium (disk, memory etc.) to be executed by such a processor 1002.

The processor 1002 is configured to read from and write to the memory 1004. The processor 1002 may also comprise an output interface via which data and/or commands are output by the processor 1002 and an input interface via which data and/or commands are input to the processor 1002.

The memory 1004 stores a computer program 1006 comprising computer program instructions (computer program code) that controls the operation of the apparatus when loaded into the processor 1002. The computer program instructions, of the computer program 1006, provide the logic and routines that enables the apparatus to perform the methods illustrated in the Figs. The processor 1002 by reading the memory 1004 is able to load and execute the computer program 1006.

The controller 1000 therefore comprises: at least one processor 1002; and at least one memory 1004 storing instructions that, when executed by the at least one processor 1002, cause a UE 110 to perform at least:
receiving 300, from a master node 120M, preparation configurations for at least a first candidate target PSCell (primary secondary cell) and a second candidate target PSCell, wherein same MCG (Master Cell Group) configuration is shared among at least the first candidate target PSCell and the second candidate target PSCell;
performing 302 a PSCell change from a source PSCell to the first candidate target PSCell; and
retaining 304 the preparation configurations after the PSCell change, wherein the PSCell change is performed without a PCell change.

The controller 1000 therefore comprises: at least one processor 1002; and at least one memory 1004 storing instructions that, when executed by the at least one processor 1002, cause an MN to perform at least:
requesting 310 configuration information from at least a first candidate target secondary node associated with a first candidate target PSCell and at least a second candidate target secondary node associated with a second candidate target PSCell;
receiving 312 the requested configuration information; and
transmitting 314, to a UE 110 preparation configurations for at least the first candidate target PSCell (primary secondary cell) and the second candidate target PSCell, wherein same MCG (Master Cell Group) configuration is shared among at least the first candidate target PSCell and the second candidate target PSCell.

The computer program 1006 may arrive at the apparatus via any suitable delivery mechanism 1008. The delivery mechanism 1008 may be, for example, a machine-readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1006. The delivery mechanism may be a signal configured to reliably transfer the computer program 1006. The apparatus may propagate or transmit the computer program 1006 as a computer data signal.

The computer program 1006 can comprise computer program instructions for causing a UE 110 to perform at least the following or for performing at least the following: receiving 300, from a master node 120M, preparation configurations for at least a first candidate target PSCell (primary secondary cell) and a second candidate target PSCell, wherein same MCG (Master Cell Group) configuration is shared among at least the first candidate target PSCell and the second candidate target PSCell;
performing 302 a PSCell change from a source PSCell to the first candidate target PSCell; and
retaining 304 the preparation configurations after the PSCell change, wherein the PSCell change is performed without a PCell change.

The computer program 1006 can comprise computer program instructions for causing an MN to perform at least the following or for performing at least the following:
requesting 310 configuration information from at least a first candidate target secondary node associated with a first candidate target PSCell and at least a second candidate target secondary node associated with a second candidate target PSCell;
receiving 312 the requested configuration information; and
transmitting 314, to a UE 110 preparation configurations for at least the first candidate target PSCell (primary secondary cell) and the second candidate target PSCell, wherein same MCG (Master Cell Group) configuration is shared among at least the first candidate target PSCell and the second candidate target PSCell.

The computer program instructions may be comprised in a computer program, a non-transitory computer readable medium, a computer program product, a machine-readable medium. In some but not necessarily all examples, the computer program instructions may be distributed over more than one computer program.

Although the memory 1004 is illustrated as a single component/circuitry it may be implemented as one or more separate components/circuitry some or all of which may be integrated/removable and/or may provide permanent/semi-permanent/dynamic/cached storage.

Although the processor 1002 is illustrated as a single component/circuitry it may be implemented as one or more separate components/circuitry some or all of which may be integrated/removable. The processor 1002 may be a single core or multi-core processor.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A User Equipment comprising means for:
receiving, from a master node, preparation configurations for at least a first candidate target PSCell (primary secondary cell) and a second candidate target PSCell, wherein same MCG (Master Cell Group) configuration is shared among at least the first candidate target PSCell and the second candidate target PSCell;
performing a PSCell change from a source PSCell to the first candidate target PSCell; and
retaining the preparation configurations after the PSCell change, wherein the PSCell change is performed without a PCell change.

2.-19. (canceled)
